(19) United States
(12) Patent Application Publication
(10) Pub. No.: US 2022/0246917 A1
(43) Pub. Date: Aug. 4, 2022

(54) ANODE ACTIVE MATERIAL FOR LITHIUM SECONDARY BATTERY AND METHOD OF MANUFACTURING THE SAME

(71) Applicant: SK INNOVATION CO., LTD., Seoul (KR)

(72) Inventors: Jong Hyuk LEE, Daejeon (KR); Hee Gyoung KANG, Daejeon (KR); Mi Ryeong LEE, Daejeon (KR)

(21) Appl. No.: 17/578,016

(22) Filed: Jan. 18, 2022

(30) Foreign Application Priority Data
Feb. 1, 2021 (KR) 10-2021-0014359

(51) Int. Cl. H01M 4/36; H01M 4/587

(52) U.S. Cl. CPC H01M 4/366; H01M 2004/027; H01M 4/587

(57) ABSTRACT

According to embodiments of the present invention, an anode active material for a lithium secondary battery may include carbon-based particles and a first coating layer coupled to at least a portion of the surface of the carbon-based particles and including an inorganic material. In addition, the embodiments of the present invention provides an anode active material including a second coating layer which includes lithium titanic acid and is coupled to the surface of the carbon-based particles or at least a portion of a surface of the first coating layer.

### CROSS-REFERENCE TO RELATED APPLICATION(S)

This application claims priority to Korean Patent Application No. 10-2021-0014359 filed on Feb. 1, 2021 in the Korean Intellectual Property Office (KIPO), the entire disclosure of which is incorporated by reference herein.

### BACKGROUND OF THE INVENTION

### 1. Field of the Invention

The present invention relates to an anode active material for a lithium secondary battery and a method of manufacturing the same.

### 2. Description of the Related Art

A secondary battery is a battery which can be repeatedly charged and discharged. With rapid progress of information and communication, and display industries, the secondary battery has been widely applied to various portable telecommunication electronic devices such as a camcorder, a mobile phone, a laptop computer as a power source thereof. Recently, a battery pack including the secondary battery has also been developed and applied to an eco-friendly automobile such as a hybrid vehicle as a power source thereof.

Examples of the secondary battery may include a lithium secondary battery, a nickel-cadmium battery, a nickel-hydrogen battery and the like. Among them, the lithium secondary battery has a high operating voltage and a high energy density per unit weight, and is advantageous in terms of a charging speed and light weight, such that development thereof has been proceeded in this regard.

The lithium secondary battery may include: an electrode assembly including a cathode, an anode, and a separation membrane (separator); and an electrolyte in which the electrode assembly is impregnated. In addition, the lithium secondary battery may further include, for example, a pouch-shaped outer case in which the electrode assembly and the electrolyte are housed.

For example, the lithium secondary battery may include an anode made of a carbon material etc. capable of intercalating and deintercalating lithium ions, a cathode made of a lithium-containing oxide, etc., and a non-aqueous electrolyte in which an appropriate amount of lithium salt is dissolved in a mixed organic solvent.

When a carbon-based material is applied to the lithium secondary battery as an anode active material, charge/discharge potential of lithium is lower than a stable range of the existing non-aqueous electrolyte, such that a decomposition reaction of electrolyte occurs during charging or discharging the secondary battery. Thereby, a solid electrolyte interface (SEI) or solid electrolyte interphase (SEI) film is formed on a surface of the carbon-based anode active material. The SEI film is repeatedly decomposed and formed through repeated charging and discharging processes. If the film is unstably formed, initial charge/discharge efficiency, high rate characteristics and life-span characteristics of the lithium secondary battery are deteriorated.

For example, Korean Patent Registration Publication No. 10-0326446 discloses an anode active material to which a spherical carbon-based material is applied, but a degradation in the charge/discharge efficiency and life-span characteristics may be caused by the decomposition reaction of the electrolyte.

### PRIOR ART DOCUMENT

### [Patent Document]

Korean Patent Registration Publication No. 10-0326446

### SUMMARY OF THE INVENTION

One object of the present invention is to provide an anode active material for a lithium secondary battery having improved life-span characteristics and electrical properties, and a method of manufacturing the same.

Another object of the present invention is to provide a lithium secondary battery having improved life-span characteristics and electrical properties.

To achieve the above objects, according to an aspect of the present invention, there is provided an anode active material for a lithium secondary battery including: carbon-based particles; a first coating layer coupled to at least a portion of a surface of the carbon-based particles; and a second coating layer which comprises lithium titanic acid and is coupled to at least a portion of a surface of the first coating layer.

In some embodiments, the first coating layer may include an inorganic substance including at least one of boron (B), aluminum (Al), phosphorus (P), sulfur (S), nitrogen (N), titanium (Ti), zirconium (Zr) and silicon (Si).

In some embodiments, the first coating layer may include at least one of boron oxide, aluminum oxide, zirconium oxide, silicon oxide, zinc oxide and titanium oxide.

In some embodiments, the first coating layer may be included in an amount of 0.1 to 1.5% by weight based on a total weight of the anode active material.

In some embodiments, the first coating layer may further include a linear conductive material.

In some embodiments, the linear conductive material may include at least one of carbon nanotube (CNT), carbon nanofiber (CNF), metal fiber, vapor-grown carbon fiber (VGCF) and graphene.

In some embodiments, the linear conductive material may be included in an amount of 5 to 70% by weight based on a total weight of the first coating layer.

In some embodiments, the lithium titanic acid may be represented by Formula 1 below:

LixTiyMwO12−zAz [Formula 1]

(In Formula 1, x, y, w and z may be in a range of 0.5≤x≤4, 1≤y≤5, 0≤w≤0.17, 0≤z≤0.17, respectively, and M may be at least one element selected from Mn, Mg, Sr, Ba, B, Al, Si, Zr and W).

In some embodiments, the second coating layer may be directly coated on the first coating layer.

In some embodiments, the direct coating may be performed using a liquid coating method.

In some embodiments, the second coating layer may be formed on the outermost side of the anode active material.

In some embodiments, the second coating layer may be included in an amount of 0.1 to 5% by weight based on the total weight of the anode active material.

In addition, according to another aspect of the present invention, there is provided a method of manufacturing an anode active material for a lithium secondary battery, the method including: preparing carbon-based particles; mixing a first coating liquid including an inorganic material with the carbon-based particles and drying the mixture to obtain an anode active material precursor; and mixing the anode active material precursor with a second coating liquid including lithium titanic acid and drying the mixture.

In some embodiments, the first coating liquid may be formed by dispersing an inorganic material including at least one of boron (B), aluminum (Al), phosphorus (P), sulfur (S), nitrogen (N), titanium (Ti), zirconium (Zr) and silicon (Si) in a solvent.

In some embodiments, the first coating liquid may further include a linear conductive material.

Further, according to another aspect of the present invention, there is provided a lithium secondary battery including: an anode which comprises the anode active material for a lithium secondary battery of any one according to the embodiments; a cathode; and a separation membrane interposed between the anode and the cathode.

According to the anode active material for a lithium secondary battery according to exemplary embodiments of the present invention, it is possible to suppress a decomposition reaction of an electrolyte occurring on the surface of the anode active material due to lithium titanic acid capable of forming a stable interface with the electrolyte, and implement excellent performance for flowing lithium ions in and out of an electrode.

In the anode active material for a lithium secondary battery according to exemplary embodiments of the present invention, the second coating layer including lithium titanic acid may be formed on the surface of the first coating layer to implement a more robust and uniform lithium titanate coating film.

According to some exemplary embodiments of the present invention, the first coating layer may further include a linear conductive material to further improve a mechanical strength of the first coating layer, thus to prevent detachment and deformation of the first coating layer due to the repeated charging and discharging, and electron transport paths may be formed between the particles, within the particles, and between the coating layers to improve an output performance of the lithium ion battery.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 are a schematic plan view and a cross-sectional view illustrating a lithium secondary battery according to exemplary embodiments, respectively.

### DETAILED DESCRIPTION OF THE INVENTION

According to embodiments of the present invention, an anode active material for a lithium secondary battery may include carbon-based particles and a first coating layer coupled to at least a portion of the surface of the carbon-based particles and including an inorganic material. In addition, the embodiments of the present invention provides an anode active material including a second coating layer which includes lithium titanic acid and is coupled to at least a portion of a surface of the first coating layer.

Hereinafter, preferred embodiments of the present invention will be described in detail with reference to the accompanying drawings. However, since the drawings attached to the present disclosure are only given for illustrating one of preferable various embodiments of present invention to easily understand the technical spirit of the present invention with the above-described invention, it should not be construed as limited to such a description illustrated in the drawings.

<Anode Active Material for Lithium Secondary Battery and Method of Manufacturing the Same>

The anode active material according to embodiments of the present invention may include carbon-based particles, a first coating layer coupled to at least a portion of a surface of the carbon-based particles, and a second coating layer which includes lithium titanic acid and is coupled to at least a portion of the surface of the first coating layer.

The anode active material for a lithium secondary battery functions to intercalate and deintercalate lithium ions, and may use carbon-based particles as a material thereof. The carbon-based particles may include at least one of artificial graphite, natural graphite, graphitized carbon fiber, graphitized mesocarbon microbead, petroleum cokes, resin baked body, carbon fiber, pyrolytic carbon, SiOx/carbon-based composite, and Si/graphite composite, for example.

The carbon-based particles used herein may have any shape without particular limitation thereof so long as the anode active material for a lithium secondary battery can function to intercalate and deintercalate lithium ions. However, in terms of improving the function of the anode active material for a lithium secondary battery, for example, the particles may have a spherical or plate shape.

The carbon-based particles may have an average particle diameter (D₅₀) of about 7 μm to about 30 μm, for example, but it is not limited thereto. For example, the carbon-based particles may include secondary particles having an average particle diameter of 10 to 25 μm formed by including primary particles having an average particle diameter of 5 to 15 μm.

The first coating layer is a coated layer coupled to at least a portion of the surface of the carbon-based particles, and functions to prevent the lithium titanic acid of the second coating layer from coming into direct contact with the carbon-based particles. Accordingly, it is possible to prevent oxidation of the carbon-based particles by reacting with lithium titanic acid at a high temperature during preparation of the anode active material.

In exemplary embodiments, the first coating layer may use any inorganic material so long as it can inhibit a reduction reaction of the carbon-based particles with lithium titanic acid without particular limitation thereof, and in some embodiments, may include an inorganic material including at least one of boron (B), aluminum (Al), phosphorus (P), sulfur (S), nitrogen (N), titanium (Ti), zirconium (Zr) and silicon (Si).

For example, the first coating layer may include at least one of boron oxide, aluminum oxide, zirconium oxide, silicon oxide, zinc oxide and titanium oxide.

In exemplary embodiments, the first coating layer may be included in an amount of 0.1 to 1.5% by weight (‘wt. %’) based on a total weight of the anode active material. When the amount of the first coating layer exceeds 1.5 wt. %, input/output performance of lithium ions may be reduced. When the amount of the first coating layer is less than 0.1 wt. %, an oxidation-reduction reaction between the carbon-based particles and lithium titanic acid may not be effectively prevented, and irreversible capacity of the lithium secondary battery may be increased.

In exemplary embodiments, the first coating layer may include a linear conductive material. Accordingly, a mechanical strength of the first coating layer including a vitrified inorganic material may be further improved, such that detachment of the first coating layer due to repeated charging and discharging may be prevented. In addition, since electrons may easily move through the linear conductive material, the output performance and life-span of the battery may be improved.

In the present invention, the term “linear conductive material” refers to a conductive material having a fibrous structure. It is preferable that the linear conductive material has good conductivity while being electrochemically stable, and forms a fibrous structure. The shape of the fibrous structure is not particularly limited, and may have, for example, a cylindrical or hollow shape.

The linear conductive material may have an aspect ratio of 2 or more, 3 or more, 4 or more, 5 or more, 10 or more, 20 or more, 50 or more, or 100 or more. In this case, the aspect ratio of the linear conductive material may be defined as a ratio of a maximum value and a minimum value of lengths between both ends of the conductive material. Accordingly, the linear conductive material may be three-dimensionally dispersed in the first coating layer to form a conductive network and improve electrical conductivity of an anode.

For example, the linear conductive material may be at least one selected from the group consisting of fine fibrous carbon having a diameter of less than 100 nm and fibrous carbon having a diameter of 100 nm or more. Therefore, it is possible to improve the electrical conductivity of the anode active material and enhance the mechanical strength of the first coating layer to prevent a deformation of the lithium secondary battery even during repeated charging and discharging and improve stability.

In some exemplary embodiments, the linear conductive material may include at least one of a carbon nanotube (CNT), a carbon nanofiber (CNF), a metal fiber, a vapor-grown carbon fiber (VGCF) and graphene.

In some exemplary embodiments, the metal fiber may include at least one of copper (Cu), nickel (Ni), aluminum (Al), iron (Fe), silver (Ag), gold (Au), platinum (Pt), zinc (Zn), titanium (Ti), or an alloy thereof. Accordingly, it is possible to form the first coating layer having intrinsic mechanical properties, electrical conductivity, heat resistance, and corrosion resistance of metal.

In exemplary embodiments, the linear conductive material may be included in an amount of 5 to 70 wt. % based on the total weight of the first coating layer. When the amount of the linear conductive material is less than 5 wt. %, the inorganic material layer having relatively low conductivity may reduce the electrical conductivity between the particles of the anode active material, and efficiency characteristics of the lithium secondary battery may be decreased. When the amount of the linear conductive material exceeds 70 wt. %, a film of the first coating layer is not properly formed due to a high specific surface area of the linear conductive material, such that a reduction reaction between carbons of the anode active material and the carbon-based linear conductive material and lithium titanate of the second coating layer may occur. In addition, since the specific surface area of the anode active material is increased, unwanted side reactions may be induced during storage and charging/discharging of the lithium secondary battery.

The first coating layer may have an average thickness of about 0.01 to about 0.3 μm, for example, which may be controlled according to a content of the first coating layer. However, when the thickness of the first coating layer is less than 0.01 μm, the reduction reaction of the lithium titanate cannot be sufficiently prevented, such that the irreversible capacity of the battery may be increased. In addition, when the thickness of the coating layer exceeds 0.3 μm, the first coating layer may act as a resistive film to interrupt electron conduction into the carbon-based particles, and thereby the input/output performance of lithium ions may be reduced.

Since the second coating layer includes lithium titanic acid, it is possible to suppress a decomposition reaction of an electrolyte of the anode active material, and improve the life-span characteristics and efficiency characteristics of the lithium secondary battery while implementing excellent performance for flowing lithium ions in and out of an electrode.

In exemplary embodiments, the lithium titanic acid may be represented by Formula 1 below.

LiₓTi_{y}M_{w}O_{12-z}A_{z} [Formula 1]

(In Formula 1, x, y, x and z may be in a range of 0.5≤x≤4, 1≤y≤5, 0≤w≤0.17, and 0≤z≤0.17, respectively, and M may be at least one element selected from Mn, Mg, Sr, Ba, B, Al, Si, Zr and W)

In exemplary embodiments, the second coating layer may have a weight of 0.1 to 5 wt. % based on the total weight of the anode active material. When the weight of the second coating layer is less than about 0.1 wt. %, the second coating layer is not sufficiently coated on the outermost surface of the anode active material, such that the decomposition reaction of the electrolyte cannot be effectively suppressed. When the content of the lithium titanic acid exceeds about 5 wt. %, the entire energy density of the anode active material may be reduced due to the low energy density of the lithium titanic acid, and thus the capacity characteristics of the lithium secondary battery may be deteriorated.

In exemplary embodiments, the second coating layer may be directly coated on the first coating layer. In addition, the second coating layer may be formed on the outermost portion of the anode active material.

The direct coating may be performed by a liquid coating method using a coating liquid. In the case of liquid coating, compared to coating performed by a mechanical friction method, a frictional force generated on the first coating layer of the anode active material powder by a lubricating action of the liquid raw material during the coating and mixing process may be reduced, thereby decreasing damage to the first coating layer. In addition, since the liquid coating contains a larger amount of solvent than coating by the mechanical friction method, it is possible to easily form a coating with a more uniform and low specific surface area.

When the coating has the above-described physical properties, it is possible to form the second coating layer which is robust and uniform, and it is possible to further improve rate characteristics and capacity characteristics of the lithium secondary battery. In addition, lithium titanic acid surrounding the outermost portion of the anode active material may suppress a side reaction between the anode active material and the electrolyte, and may improve performance for flowing lithium ions in and out of an electrode.

The anode active material according to embodiments of the present invention may be manufactured by a mechanical coating method using the mechanical frictional force or a wet coating method using a coating liquid. Hereinafter, the wet coating method will be described as an example, but the present invention is not limited thereto.

A method of manufacturing an anode active material according to embodiments of the present invention may include: preparing carbon-based particles; mixing a first coating liquid including an inorganic material with the carbon-based particles and drying the mixture to obtain an anode active material precursor; and mixing the anode active material precursor with a second coating liquid including lithium titanic acid and drying the mixture.

In some exemplary embodiments, the first coating liquid may be formed by dissolving boron oxide in a solvent.

The solvent is not particularly limited so long as it can dissolve the boron oxide, and may be at least one of water and ethanol, for example.

In some exemplary embodiments, the first coating liquid may further include a linear conductive material. The linear conductive material may be dispersed and mixed in a solvent, and the dispersion may be performed by a method commonly used in the art, for example, a dispersion treatment may be performed using an ultrasonic dispersion device. Accordingly, the linear conductive material made of nanometer-sized particles may be evenly dispersed in the coating liquid without agglomeration.

In some exemplary embodiments, the second coating liquid may include a lithium titanic acid precursor. Accordingly, the lithium titanic acid may be directly synthesized on at least a portion of the surface of the first coating layer, and a more robust and uniform second coating layer may be formed.

After coating with the first coating liquid or the second coating liquid, drying and heat treatment may be further performed.

The drying may be performed at room temperature to a temperature of 100° C. Therefore, the first coating using the coating liquid is possible only with a simple process, and the coating layer may be formed on the surface of the anode active material.

The heat treatment may be performed by heat treating the dried product under an atmospheric atmosphere or an inert gas atmosphere. For example, the heat treatment may be performed at 400 to 600° C. for 10 minutes to 1 hour. Therefore, it is possible to improve the long-term life performance of the battery by firmly fixing the attachment of the coating layer.

<Lithium Secondary Battery>

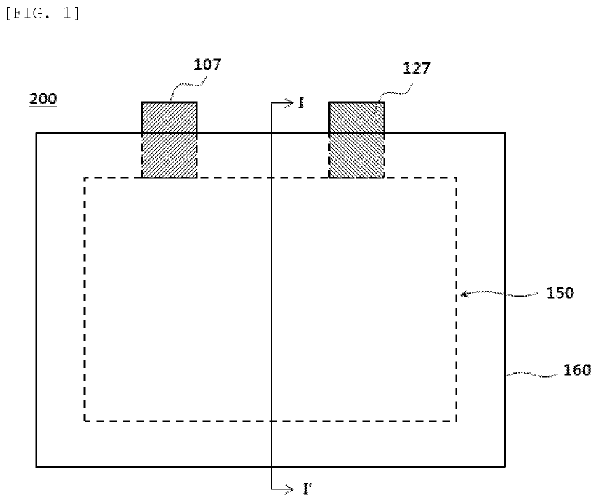

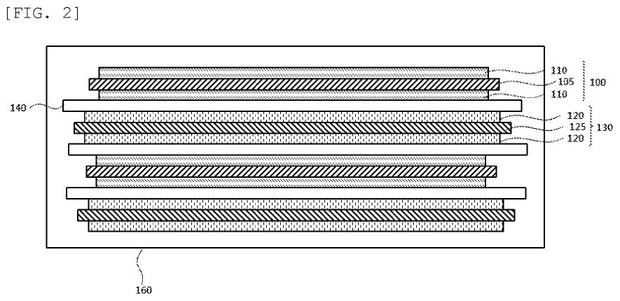

FIGS. 1 and 2 are a schematic plan view and a cross-sectional views illustrating a lithium secondary battery according to exemplary embodiments, respectively.

Referring to FIGS. 1 and 2, the lithium secondary battery may include an electrode assembly including a cathode 100, an anode 130, and a separation membrane 140 interposed between the cathode and the anode. The electrode assembly may be housed in a case 160 together with an electrolyte to be impregnated.

The cathode 100 may include a cathode active material layer 110 formed by applying a slurry containing the cathode active material to a cathode current collector 105.

For the cathode current collector 105, aluminum or an aluminum alloy may be used, but it is not limited thereto, and stainless steel, nickel, aluminum, titanium or an alloy thereof; and aluminum or stainless steel whose surface is subjected to surface treatment with carbon, nickel, titanium, or silver, etc. may be used.

The cathode active material may include a compound capable of reversibly intercalating and deintercalating lithium ions.

In exemplary embodiments, the cathode active material may include a lithium-transition metal oxide. For example, the lithium-transition metal oxide may include nickel (Ni), and may further include at least one of cobalt (Co) and manganese (Mn).

For example, the lithium-transition metal oxide may be represented by Formula 1 below.

Li₁₊ₐNi_{1-(x+y)}CoₓM_{y}O₂ [Formula 1]

In Formula 1, α, x and y may be in a range of −0.05≤α≤0.15, 0.01≤x≤0.3, and 0.01≤y≤0.3, respectively, and M may be at least one element selected from Mn, Mg, Sr, Ba, B, Al, Si, Ti, Zr and W.

A slurry may be prepared by mixing the cathode active material with a binder, a conductive material and/or a dispersant in a solvent, followed by stirring the same. The slurry may be coated on the cathode current collector 105, followed by compressing and drying to manufacture the cathode 100.

As the solvent, a non-aqueous solvent may be used. For example, as the non-aqueous solvent, N-methyl-2-pyrrolidone (NMP), dimethylformamide, dimethylacetamide, N,N-dimethylaminopropylamine, ethylene oxide, tetrahydrofuran, etc. may be used, but it is not limited thereto.

As the binder, any material used in the art may be used without particular limitation thereof, and for example, an organic binder such as vinylidene fluoride-hexafluoropropylene copolymer (PVDF-co-HFP), polyvinylidene fluoride (PVDF), polyacrylonitrile, polymethyl methacrylate, etc., or at least one aqueous binder such as styrene-butadiene rubber (SBR) may be used together with a thickener such as carboxymethyl cellulose (CMC).

In this case, a PVDF-based binder may be used as a cathode forming binder. In this case, an amount of the binder for forming the cathode active material layer may be reduced and an amount of the cathode active material may be relatively increased, thereby improving the output and capacity of the secondary battery.

The conductive material may be included to facilitate electron transfer between the active material particles. For example, the conductive material may include a carbon-based conductive material such as graphite, carbon black, graphene, or carbon nanotubes and/or a metal-based conductive material such as tin, tin oxide, titanium oxide, or a perovskite material such as LaSrCoO₃, and LaSrMnO₃.

The anode 130 may include an anode active material layer 120 by applying a slurry including the anode active material to an anode current collector 125.

A slurry may be prepared by mixing the anode active material of the present invention with a binder, a conductive material and/or a dispersant in a solvent, followed by stirring the same, and then the slurry may be applied to (coated on) the anode current collector 125, followed by compressing and drying to manufacture the anode 130 for a lithium secondary battery of the present invention.

As the solvent, a non-aqueous solvent may be generally used. As the non-aqueous solvent, for example, N-methyl-2-pyrrolidone (NMP), dimethylformamide, dimethylacetamide, N, N-dimethylaminopropylamine, ethylene oxide, tetrahydrofuran, etc. may be used, but it is not limited thereto.

As the binder, any material used in the art may be used without particular limitation thereof, and for example, an organic binder such as vinylidene fluoride-hexafluoropropylene copolymer (PVDF-co-HFP), polyvinylidene fluoride (PVDF), polyacrylonitrile, polymethyl methacrylate, etc., or at least one aqueous binder such as styrene-butadiene rubber (SBR) may be used together with a thickener such as carboxymethyl cellulose (CMC).

The content of the binder may be set to an amount required to form an electrode, and may be 3 wt. % or less based on a total weight of the anode active material and the binder without particular limitation thereof, in order to improve resistance characteristics in the electrode. Meanwhile, a lower limit of the binder content is not particularly limited, but may be provided to a level capable of maintaining the function of the electrode, and may be, for example, 0.5 wt. % or 1 wt. % based on the total weight of the anode active material and the binder.

As the conductive material, a conventional conductive carbon material may be used without particular limitation thereof.

For the anode current collector 125, any metal may be used so long as it has high conductivity and allows the slurry of the anode active material to be easily adhered thereto, without reactivity in a voltage range of the battery. For example, copper or a copper alloy may be used, but it is not limited thereto, and stainless steel, nickel, copper, titanium or an alloy thereof; and copper or stainless steel whose surface is subjected to surface treatment with carbon, nickel, titanium, or silver, etc. may be used.

The slurry may be coated on at least one surface of the anode current collector 125, followed by compressing and drying to manufacture the anode 130.

According to an embodiment of the present invention, in relation to an electrode density, the anode active material layer 120 formed by coating the anode active material have an electrode density of 1.45 g/cm³ or more, for example, and an upper limit thereof is not particularly limited. When the electrode density of the anode satisfies the above range, output, life-span, and high temperature storage characteristics may be improved during manufacturing the electrode.

The separation membrane 140 may be interposed between the cathode 100 and the anode 130. The separation membrane 140 may include a porous polymer film made of a polyolefin polymer such as ethylene homopolymer, propylene homopolymer, ethylene/butene copolymer, ethylene/hexene copolymer, ethylene/methacrylate copolymer. The separation membrane 140 may include a nonwoven fabric made of glass fiber having a high melting point, polyethylene terephthalate fiber or the like.

In some embodiments, the anode 130 may have an area (e.g., a contact area with the separation membrane 140) and/or volume larger than those/that of the cathode 100.

Thereby, lithium ions generated from the cathode 100 may smoothly move to the anode 130 without being precipitated in the middle, for example. Therefore, effects of improving the capacity and output by using the above silicon-based anode active material may be more easily implemented.

According to exemplary embodiments, an electrode cell is defined by the cathode 100, the anode 130, and the separation membrane 140, and a plurality of electrode cells are stacked to form, for example, a jelly roll type electrode assembly 150. For example, the electrode assembly 150 may be formed by winding, lamination, folding, or the like of the separation membrane 140.

The electrode assembly 150 may be housed in an outer case 160 together with an electrolyte to define the lithium secondary battery. According to exemplary embodiments, a non-aqueous electrolyte may be used as the electrolyte.

The non-aqueous electrolyte includes a lithium salt of an electrolyte and an organic solvent, and the lithium salt is represented by, for example, Li⁺X⁻, and as an anion (X⁻) of the lithium salt, F⁻, Cl⁻, Br⁻, I⁻, NO³⁻, N(CN)²⁻, BF⁴⁻, ClO⁴⁻, PF⁶⁻, (CF₃)₂PF⁴⁻, (CF₃)₃PF³⁻, (CF₃)₄PF²⁻, (CF₃)₅PF⁻, (CF₃)₆P⁻, CF₃SO³⁻, CF₃CF₂SO³⁻, (CF₃SO₂)₂N⁻, (FSO₂)₂N⁻, CF₃CO₂⁻, CH₃CO²⁻, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxyethane, diethoxyethane, vinylene carbonate, sulforane, γ-butyrolactone, propylene sulfite, tetrahydrofurane, and the like may be used. These compounds may be used alone or in combination of two or more thereof.

As shown in FIG. 1, electrode tabs (a cathode tab and an anode tab) may protrude from the cathode current collector 105 and the anode current collector 125, respectively, which belong to each electrode cell, and may extend to one side of the case 160. The electrode tabs may be fused together with the one side of the case 160 to form electrode leads (a cathode lead 107 and an anode lead 127) extending or exposed to an outside of the case 160.

The lithium secondary battery may be manufactured, for example, in a cylindrical shape using a can, a square shape, a pouch type or a coin shape.

Hereinafter, specific experimental examples are proposed to facilitate understanding of the present invention. However, the following examples are only given for illustrating the present invention and those skilled in the art will obviously understand that various alterations and modifications are possible within the scope and spirit of the present invention. Such alterations and modifications are duly included in the appended claims.

### EXAMPLES AND COMPARATIVE EXAMPLES

### Example 1

<Anode>

100 g of carbon-based particles composed of a graphite-based material having an average particle diameter of 11 μm were prepared. Then, 0.5 g of B₂O₃ and 0.1 g of carbon nanotubes (CNTs) were added to ethanol to prepare a first coating liquid through ultrasonic dispersion treatment.

The carbon-based particles and the first coating liquid were mixed by mechanically blending at 2200 rpm in a high-speed stirrer for 10 minutes to prepare a mixture, followed by sufficiently drying the same at a temperature of 120° C. to prepare an anode active material having a coating layer uniformly formed on the surface thereof. Then, the dried product was subjected to heat treatment for 30 minutes at a temperature of 450° C. under an atmospheric atmosphere to form a first coating layer on the surface of the carbon-based particles, thus to prepare a carbon-based particle-containing first coating layer anode active material.

A second coating liquid was prepared by dissolving 1.8 g of lithium tert-butoxide and 3.8 g of titanium isopropoxide as a metal organic compound in 100 g of ethanol. After mixing the second coating liquid with the carbon-based particle-containing first coating layer anode active material, the mixture was stirred for 24 hours, followed by flow drying at 60° C. under a vacuum atmosphere while stirring the same to obtain a powder. The obtained powder was subjected to heat treatment at 500° C. under an air atmosphere to prepare an anode active material.

In this case, it was measured that the first coating layer had an amount of 0.5 wt. %, and the second coating layer had an amount of 2 wt. % based on the total weight of the anode active material.

Then, the prepared anode active material, styrene butadiene rubber (SBR), and carboxymethyl cellulose (CMC) as a thickener were mixed in a mass ratio of 97.8:1.2:1.0, and then the mixture was dispersed in distilled water from which ions were removed to prepare a composition. Then, the prepared composition was applied to one surface of a copper (Cu) foil current collector, followed by drying and rolling the same to form an anode active material layer having a size of 10 cm×10 cm×50 μm, thus to prepare an anode having an electrode density of 1.50±0.05 g/cm³.

<Cathode>

Li_{1.0}Ni_{0.6}Co_{0.2}Mn_{0.2}O₂ used as a cathode active material, Denka Black used as a conductive material, PVDF used as a binder, and N-Methyl pyrrolidine used as a solvent were mixed in a mass ratio composition of 46:2.5:1.5:50, respectively, to prepare a cathode slurry. Then, the slurry was applied to an aluminum substrate, followed by drying and pressing the same to prepare a cathode.

<Battery>

The cathode and the anode prepared as described above were respectively notched in a predetermined size and laminated, then a battery was formed by disposing a separation membrane (polyethylene, thickness: 25 μm) between a cathode plate and an anode plate. Thereafter, tap parts of the cathode and the anode were welded, respectively.

A combination of the welded cathode/separation membrane/anode was put into a pouch, followed by sealing three sides of the pouch except for one side into which an electrolyte is injected. At this time, a portion having the electrode tab was included in the sealing part. After injecting the electrolytic through the remaining one side except for the sealing part, the remaining one side was also sealed, followed by impregnation for 12 hours or more. The electrolyte used herein was prepared by dissolving 1M LiPF₆ solution in a mixed solvent of ethylene carbonate (EC)/ethylmethyl carbonate (EMC)/diethylene carbonate (DEC) (25/45/30; volume ratio), and adding 1 wt. % of vinylene carbonate (VC), 0.5 wt. % of 1,3-propene sultone (PRS), and 0.5 wt. % of lithium bis(oxalato)borate (LiBOB) thereto.

After then, pre-charging was conducted on the battery prepared as described above with a current (2.5 A) corresponding to 0.25C for 36 minutes. After 1 hour, degassing then aging for 24 hours or more were conducted, followed by formation charging-discharging (charge condition: CC-CV 0.2C 4.2 V 0.05C CUT-OFF; discharge condition: CC 0.2C 2.5 V CUT-OFF).

### Example 2

A secondary battery was manufactured according to the same procedures as described in the secondary battery manufacturing process of Example 1, except that 3.6 g of lithium tert-butoxide and 10.6 g of titanium isopropoxide as a metal organic compound were dissolved in 100 g of ethanol to prepare a second coating liquid. In this case, it was measured that the second coating layer had an amount of 4 wt. % based on the total weight of the anode active material.

### Example 3

A secondary battery was manufactured according to the same procedures as described in the secondary battery manufacturing process of Example 1, except that carbon nanotubes (CNTs) were not added to the first coating liquid.

### Comparative Example 1

A secondary battery was manufactured according to the same procedures as described in the secondary battery manufacturing process of Example 1, except that the first coating liquid included 2.5 g of B₂O₃. In this case, it was measured that the first coating layer had an amount of 2.5 wt. % based on the total weight of the anode active material.

### Comparative Example 2

A secondary battery was manufactured according to the same procedures as described in the secondary battery manufacturing process of Example 1, except that the first coating liquid included 2.5 g of B₂O₃. In this case, it was measured that the first coating layer had an amount of 5 wt. % based on the total weight of the anode active material.

### Comparative Example 3

A secondary battery was manufactured according to the same procedures as described in the secondary battery manufacturing process of Example 1, except that the first coating layer was not formed.

### Comparative Example 4

A secondary battery was manufactured according to the same procedures as described in the secondary battery manufacturing process of Example 1, except that the second coating layer was not formed.

### Comparative Example 5

A secondary battery was manufactured according to the same procedures as described in the secondary battery manufacturing process of Example 1, except that 5.4 g of lithium tert-butoxide and 15.9 g of titanium isopropoxide as a metal organic compound were dissolved in 100 g of ethanol to prepare a second coating liquid. In this case, it was measured that the second coating layer had an amount of 6 wt. % based on the total weight of the anode active material.

### Experimental Example

<Measurement of Initial Charge/Discharge Capacity>

Charging (CC/CV 0.1C 0.005 V 0.01C CUT-OFF) and discharging (CC 0.1C 1.5 V CUT-OFF) were performed once on the battery cells according to the examples and comparative examples, then initial charge capacity and discharge capacity were measured (CC: constant current, CV: constant voltage).

<Measurement of Initial Efficiency>

The initial efficiency was measured by a percentage value obtained by dividing the initial discharge amount measured above by the initial charge amount.

<Evaluation of Rate Characteristics>

Charging (CC/C V 0.1C 4.3 V 0.005C CUT-OFF) and discharging (CC 0.1C 3.0 V CUT-OFF) were performed 5 times on the battery cells according to the examples and comparative examples, then charging (CC/C V 0.1C 4.3 V CUT-OFF) and discharging (CC 2.0C 3.0 V CUT-OFF) were performed once again for evaluating rate characteristics. The rate characteristic was evaluated by dividing the 2.0C discharge capacity by the 0.1C discharge capacity of the cycle immediately before the 2.0C discharge was performed, then converting it into a percentage (%).

<Measurement of Capacity Retention Rate (Life-Span Characteristics)>

The lithium secondary batteries according to the examples and comparative examples were repeatedly charged (CC/CV 0.5C 4.3 V 0.05C CUT-OFF) and discharged (CC 1.0C 3.0 V CUT-OFF) 200 times, then the capacity retention rate was evaluated as a percentage of the discharge capacity at 200 times divided by the discharge capacity at one time.

The measured values according to the above-described experimental examples are shown in Table 1 below.

TABLE 1

| | Initial | Initial | | | |
|---|---|---|---|---|---|
| | charge | discharge | | | Capacity |
| | amount | amount | Initial | Rate | retention |
| Section | (mah/g) | (mah/g) | efficiency | characteristics | rate |
| Example 1 | 363.5 | 347.2 | 95.52% | 88.9% | 82.7% |
| Example 2 | 359.2 | 343.2 | 95.55% | 91.3% | 81.2% |
| Example 3 | 365.1 | 348.9 | 95.56% | 81.0% | 79.8% |
| Comparative | 357.0 | 340.1 | 95.27% | 75.4% | 70.3% |
| Example 1 | | | | | |
| Comparative | 348.7 | 331.1 | 94.95% | 71.5% | 67.4% |
| Example 2 | | | | | |
| Comparative | 373.7 | 348.9 | 93.36% | 70.7% | 65.3% |
| Example 3 | | | | | |
| Comparative | 372.3 | 353.0 | 94.82% | 79.4% | 72.5% |
| Example 4 | | | | | |
| Comparative | 355.1 | 339.3 | 95.55% | 89.7% | 79.8% |
| Example 5 | | | | | |

Referring to Table 1, in the case of Examples 1 to 3 which include the first coating layer and the second coating layer in the range of the content according to the present invention, excellent charge/discharge efficiency and capacity retention rate were obtained as a whole compared to the comparative examples.

On the other hand, in the case of Comparative Examples 1 and 2 which include the first coating layer in an amount of 2.5 wt. % or more based on the total weight of the anode active material, the content of the inorganic film, which is a nonconductor, was increased, such that the rate characteristics and capacity retention rate were significantly reduced. In the case of Comparative Example 3 which does not include the first coating layer, the mechanical adhesion strength of the second coating layer to the carbon-based particles was low, such that the second coating layer was easily detached, and the initial efficiency, rate characteristics, and capacity retention rate were significantly reduced. In the case of Comparative Example 4 which does not include the second coating layer, the initial efficiency and life-span characteristics were deteriorated compared to the examples due to a decrease in wettability of the electrolyte and the insufficient effect of suppressing the decomposition reaction of the electrolyte obtained by the second coating layer. In the case of Comparative Example 5 which include the second coating layer in an amount of 6 wt. % based on the total weight of the anode active material, the content of Li₄Ti₅O₁₂ having a low specific capacity was increased, such that the initial charge amount, initial discharge amount, initial efficiency and life-span characteristics were deteriorated compared to the examples.

### DESCRIPTION OF REFERENCE NUMERALS

100: Cathode
105: Cathode current collector
107: Cathode lead
110: Cathode active material layer
120: Anode active material layer
125: Anode current collector
127: Anode lead
130: Anode
140: Separation membrane
150: Electrode assembly
160: Case

What is claimed is:

1. An anode active material for a lithium secondary battery comprising:
carbon-based particles;
a first coating layer coupled to at least a portion of a surface of the carbon-based particles; and
a second coating layer which comprises lithium titanic acid and is coupled to at least a portion of a surface of the first coating layer.

2. The anode active material for a lithium secondary battery according to claim 1, wherein the first coating layer comprises an inorganic substance including at least one of boron (B), aluminum (Al), phosphorus (P), sulfur (S), nitrogen (N), titanium (Ti), zirconium (Zr) and silicon (Si).

3. The anode active material for a lithium secondary battery according to claim 1, wherein the first coating layer includes at least one of boron oxide, aluminum oxide, zirconium oxide, silicon oxide, zinc oxide and titanium oxide.

4. The anode active material for a lithium secondary battery according to claim 1, wherein the first coating layer is included in an amount of 0.1 to 1.5% by weight based on a total weight of the anode active material.

5. The anode active material for a lithium secondary battery according to claim 1, wherein the first coating layer further comprises a linear conductive material.

6. The anode active material for a lithium secondary battery according to claim 5, wherein the linear conductive material includes at least one of carbon nanotube (CNT), carbon nanofiber (CNF), metal fiber, vapor-grown carbon fiber (VGCF) and graphene.

7. The anode active material for a lithium secondary battery according to claim 5, wherein the linear conductive material is included in an amount of 5 to 70% by weight based on a total weight of the first coating layer.

8. The anode active material for a lithium secondary battery according to claim 1, wherein the lithium titanic acid is represented by Formula 1 below:
LiₓTi_{y}M_{w}O_{12-z}A_{z} [Formula 1]
(In Formula 1, x, y, w and z are in a range of 0.5≤x≤4, 1≤y≤5, 0≤w≤0.17, 0≤z≤0.17, respectively, and M is at least one element selected from Mn, Mg, Sr, Ba, B, Al, Si, Zr and W).

9. The anode active material for a lithium secondary battery according to claim 1, wherein the second coating layer is directly coated on the first coating layer.

10. The anode active material for a lithium secondary battery according to claim 1, wherein the second coating layer is formed on the outermost side of the anode active material.

11. The anode active material for a lithium secondary battery according to claim 1, wherein the second coating layer is included in an amount of 0.1 to 5% by weight based on the total weight of the anode active material.

12. A method of manufacturing an anode active material for a lithium secondary battery, the method comprising:
preparing carbon-based particles;
mixing a first coating liquid including an inorganic material with the carbon-based particles and drying the mixture to obtain an anode active material precursor; and
mixing the anode active material precursor with a second coating liquid including lithium titanic acid and drying the mixture.

13. The method according to claim 12, wherein the first coating liquid is formed by dispersing an inorganic material including at least one of boron (B), aluminum (Al), phosphorus (P), sulfur (S), nitrogen (N), titanium (Ti), zirconium (Zr) and silicon (Si) in a solvent.

14. The method according to claim 12, wherein the first coating liquid further comprises a linear conductive material.

15. A lithium secondary battery comprising:
an anode which comprises the anode active material for a lithium secondary battery according to claim 1.
